(19) United States
(12) Patent Application Publication
(10) Pub. No.: US 2024/0304089 A1
(43) Pub. Date: Sep. 12, 2024

(54) Method for Monitoring a Region Surrounding a Vehicle, Assistance System for a Vehicle, Data Exchange Device, and System for Carrying Out a Method for Monitoring a Region Surrounding a Vehicle

(71) Applicant: Bayerische Motoren Werke Aktiengesellschaft, Muenchen (DE)

(72) Inventor: Christian GLAS, Isen (DE)

(21) Appl. No.: 18/578,792

(22) PCT Filed: Jun. 20, 2022
(86) PCT No.: PCT/EP2022/066697

§ 371 Date: Jan. 12, 2024

(30) Foreign Application Priority Data
Jul. 16, 2021 (DE) 10 2021 118 457.6

(51) Int. Cl. G08G 1/16; G08G 1/0967

(52) U.S. Cl. CPC G08G 1/166; G08G 1/096766; G08G 1/164; G08G 1/165

(57) ABSTRACT

A method for monitoring a region surrounding a vehicle receives sensor data from at least one sensor of an assistance system of the vehicle. The sensor data describes the region surrounding the vehicle at a measurement time. The method additionally transmits surroundings model data from a data exchange device to the assistance system, the surroundings model data describing at least one part of the region surrounding the vehicle, and identifies vulnerable traffic participants in the region surrounding the vehicle using the sensor data and the surroundings model data. In the process, the surroundings model data is continuously generated by the data exchange device and is transmitted to the assistance system. The surroundings model data is generated in the method such that the surroundings model data describes only static objects in the at least one part of the region surrounding the vehicle. The process of detecting the vulnerable traffic participants includes the process of determining characteristic distinguishing features between the sensor data and the surroundings model data.

### BACKGROUND AND SUMMARY

The present invention relates to a method for monitoring a region surrounding a vehicle. The present invention also relates to an assistance system for a vehicle for monitoring a region surrounding the vehicle. Furthermore, the present invention relates to a data exchange device. Finally, the present invention relates to a system for carrying out a method for monitoring a region surrounding a vehicle.

Vehicles having assistance systems or at least partially automated vehicles capture their surroundings by means of sensors, for example lidar, radar or ultrasonic sensors. In addition, cameras can also be used to capture the surroundings of a vehicle. Moving dynamic objects or non-static objects, for example pedestrians, cyclists or other vehicles, can therefore be captured at the same time as the static environment. Static and non-static objects are distinguished by means of a sensor data evaluation. The distinction between static and non-static objects is decisive for the assistance system or the at least partially automated driving functions. In particular, the reliable detection of dynamic or non-static objects in the case of objects worthy of protection, such as pedestrians or cyclists, is decisive for the safety of the vehicle and also general traffic safety in confusing urban traffic. In summary, the protection of vulnerable road users is therefore particularly important. Therefore, it is necessary to reliably detect vulnerable road users.

In order to monitor a region surrounding a vehicle and, in particular, to capture vulnerable road users more reliably, there are numerous methods for fusing sensor data according to the prior art. One particular form of sensor data fusion is based on exchanging sensor data from various vehicles and/or exchanging sensor data or information from vehicles with data exchange devices, for example a backend.

The published patent application DE 10 2016 218 934 A1 describes a method for exchanging and fusing environmental data from at least two vehicles or one vehicle with a stationary infrastructure transmitter for providing environmental data. The vehicle has at least one environmental sensor and a communication interface for exchanging data and a computing unit for evaluating and fusing the environmental data from the ego vehicle and from the at least one other vehicle or the infrastructure transmitter. In this case, provision is made for at least the ego vehicle to capture, from the other vehicle or the infrastructure transmitter, which environmental data are available there and, if there is redundancy, for its own capture of the environmental data to be adapted and/or for the evaluation or data fusion to be adapted, in particular for redundant data or regions to not be captured or processed and for resources that become available to preferably be used in an optimized manner for other tasks.

The document DE 10 2018 220 018 A1 discloses a method for detecting objects by means of sensor systems of vehicles, wherein a plurality of vehicles are networked to one another in this case. Each vehicle has a sensor system for detecting objects. The data and/or information captured by the individual vehicles when detecting objects are fused with one another and their plausibility is checked.

DE 10 2018 221 933 A1 describes a distributed data exchange system for vehicles having a local buffer memory for buffering the data. The distributed data exchange system also has a transmitting apparatus in a first vehicle for transmitting the data to be buffered to the local buffer memory via a first short-range interface, a receiving apparatus in a second vehicle driving past the buffer memory for receiving the buffered data from the local buffer memory via a second short-range interface, and a processor connected to the buffer memory. The processor is configured to process the data transmitted to the buffer memory, to generate environmental model data, to write the environmental model data to the buffer memory and to transmit the data to the second vehicle.

The document DE 10 2013 017 626 A1 discloses a method for warning further road users about pedestrians by means of a motor vehicle having at least one environment capture means, at least one optical and/or acoustic warning means for advising further road users, and a control apparatus. In this case, environmental data are captured by the environment capture means. In addition, environmental data are evaluated by the control apparatus. Furthermore, at least one trigger condition is checked if a pedestrian is detected in the environmental data. Finally, the warning means is actuated if the trigger condition is met.

The object of the present invention is to show a solution of how the detection of vulnerable road users and therefore monitoring of a region surrounding a vehicle can be improved.

This object is achieved, according to the invention, by means of a method, an assistance system, a data exchange device and a system having the features according to the independent claims. Advantageous developments are specified in the dependent claims.

A method according to the invention for monitoring a region surrounding a vehicle comprises receiving sensor data from at least one sensor of an assistance system of the vehicle which describe the region surrounding the vehicle at a measurement time. The method additionally comprises transmitting environmental model data from a data exchange device to the assistance system, wherein the environmental model data describe at least one part of the region surrounding the vehicle. In addition, the method comprises detecting vulnerable road users in the surrounding region on the basis of the sensor data and the environmental model data. In this case, in the method according to the invention, the environmental model data are continuously generated by the data exchange device and transmitted to the assistance system. Furthermore, in the method according to the invention, the environmental model data are generated in such a manner that they describe only static objects in the at least one part of the surrounding region. Finally, the detection of the vulnerable road users comprises determining characteristic distinguishing features between the sensor data and the environmental model data.

The method according to the invention is therefore used to monitor the region surrounding the vehicle. Further road users and, in particular, vulnerable road users are therefore intended to be detected within the surrounding region. The method is based on the idea of improving detection of the vulnerable road users by means of additional environmental model data which describe a static environment or static objects in the at least one part of the surrounding region.

In this case, the assistance system of the vehicle can receive sensor data. These sensor data may come, for example, from a radar, lidar and/or ultrasonic sensor. In this case, the sensor data may be in the form of a point cloud and/or an object list. If the sensor data come from a lidar sensor, for example, the region surrounding the vehicle at the measurement time may be described by a multiplicity of reflection points. The reflection points are in turn combined to form a so-called point cloud. A reflection point may typically be determined by a time-of-flight measurement of an emitted laser beam which is reflected at an object in the region surrounding the vehicle. The sensor data may also come from a camera and may be provided in the form of image data. The sensor data may describe the surrounding region in the optical wavelength range and/or in the infrared wavelength range.

In addition to the sensor data, the assistance system may receive environmental model data from the data exchange device. The environmental model data may describe, for example, the same region surrounding the vehicle as the sensor data. However, it is likewise also possible for the environmental model data to describe only a part of the region surrounding the vehicle. It should be emphasized that the environmental model data describe only or exclusively static objects. Static objects may be, for example, walls, buildings, light signaling systems or trees. In addition, parked vehicles or stationary vehicles may be static objects. The assistance system of the vehicle is aware of at least one part of the region surrounding the vehicle, in particular the static environment, on the basis of the received environmental model data. Vulnerable road users, for example pedestrians, cyclists, animals and other objects worthy of protection, can be detected in good time, in particular in confusing urban traffic, on the basis of the sensor data captured by the sensor of the assistance system of the vehicle in combination with the above-described (static) environmental model data.

The environmental model data transmitted from the data exchange device to the assistance system of the vehicle are constantly updated, that is to say, in particular, are continuously generated. For example, the environmental model data may be generated by means of sensor data from further vehicles or further road users that have already captured the region surrounding the vehicle at an earlier time. It is therefore possible for road users that have already captured the region surrounding the vehicle at an earlier time to make their data available to the data exchange device. The data exchange device can therefore determine the static environment in the surrounding region, for example by means of averaging or else by means of complex fusion algorithms. It is therefore contemplated for the data exchange device to fuse the data provided by the further road users and/or to remove non-static objects and thus generate environmental model data which describe the static environment of the vehicle in the at least one part of the surrounding region.

Environmental model data generated in this manner can now be used to already detect the vulnerable road users in good time and in a reliable manner. This can be carried out, for example, by determining characteristic distinguishing features between the sensor data and the environmental model data. A characteristic distinguishing feature may be determined, for example, by comparing the contours and shapes derived from the sensor data and the shapes and contours derived from the environmental model data.

In addition, vulnerable road users or dynamic objects worthy of protection can also be implicitly inferred using the method according to the invention. If, for example, individual static objects cannot be captured by the at least one sensor of the assistance system of the vehicle because a non-static object is located between the sensor and the static object and the reflectivity properties of the non-static object are such that the non-static object cannot be captured and/or classified, the non-static object in between can be implicitly inferred on the basis of the environmental model data. This additional information can also be referred to as an implicit knowledge gain for the assistance system of the vehicle. The detection of the vulnerable road users by means of the implicit knowledge gain is comparable to indirectly observing exoplanets which can be observed only on account of their gravitational influence on their central star.

The characteristic distinguishing features may generally describe a difference between the environmental model data and the sensor data. The characteristic features may be assigned to the dynamic objects in the surrounding region and, in particular, to the vulnerable road users. The characteristic distinguishing features and hereby the vulnerable road users may therefore be detected within a short period of time and with little computing effort.

In one advantageous embodiment, the environmental model data are generated by means of data from at least two further sources which were recorded within a recording period. For example, the at least two further sources may be additional road users such as vehicles or motorcycles. The sources may come, for example, from the sensor data from a vehicle fleet. These data from the further sources may be aggregated online. In particular, the environmental model data may reflect the currently expected sensor measured values for the local surroundings (without moving dynamic objects). It is also contemplated for data from sensors which are fitted to infrastructure elements to be used. In other words, environmental model data may therefore also be generated by means of data from sensors that are used to monitor the traffic events. A combination of the data from the different sources mentioned is also possible. The environmental model data may therefore be generated, for example, by means of data from at least one further vehicle and a sensor which is fitted to a light signaling system or the like.

Provision may also be made for the environmental model data to be determined and/or provided for different types of sensors. For example, the environmental model data may be provided for radar, lidar, ultrasonic sensors and/or cameras. In particular, environmental model data may be generated such that only data from the at least two further sources, which have a predefined type of sensor, are taken into account. Depending on the equipment of the assistance system or the vehicle, the appropriate environmental model data may then be transmitted to the vehicle. If the assistance system or the vehicle comprises only a camera as a sensor, environmental model data which have been determined on the basis of cameras of other sources can also be transmitted to the assistance system. The characteristic distinguishing features can therefore be determined with little effort.

As a result, the region surrounding the vehicle or at least one part of the region surrounding the vehicle can be described in advance by the environmental model data. The environmental model data can then be made available to the vehicle or the assistance system of the vehicle. Consequently, the assistance system of the vehicle can receive in advance information relating to the at least one part of the region surrounding the vehicle.

It is advantageous if the measurement time of the sensor data temporally follows the recording period of the data from the at least two further sources. In other words, it is advantageous if the at least two further sources have already captured the region surrounding the vehicle or a part of the region surrounding the vehicle at an earlier time using their sensors. Environmental model data which describe only static objects in the at least one part of the surrounding region can therefore be generated using the data from the at least two further sources. These environmental model data can then be transmitted from the data exchange device to the assistance system and can therefore provide the assistance system of the vehicle in advance with information relating to the static objects in the at least one part of the surrounding region.

As a result, it is already possible to react in good time to challenges which may arise. For example, a driver of the vehicle can be pre-warned in complex inner-city scenarios. If the vehicle is in an at least partially automated driving mode and, on the basis of the environmental model data, it is expected that the imminent traffic situation is (too) complex and safe maneuvering is not possible without intervention by a driver of the vehicle, a request to take over control, a so-called hands-on request, can therefore already be output in good time.

In addition, it is advantageous if the recording period of the data from the at least two further sources is within a predetermined maximum period. If, for example, dozens of further road users that transmit data to the data exchange device pass through the region surrounding the vehicle in advance, the static objects in the at least one part of the surrounding region may change. For example, a parked vehicle may therefore even no longer be in situ at a later time. Static objects which are only temporarily static can be taken into account by means of a predetermined maximum period. It may therefore be advantageous that only those data from the at least two further sources which were recorded within the last 30 minutes are used to generate the environmental model data, for example in a heavily used region, for example in a city center. However, a predetermined maximum period of 5 minutes, 60 minutes and/or several hours is likewise also conceivable.

In addition, it is advantageous if, when determining the characteristic distinguishing features for detecting the vulnerable road users, the shapes and contours derived from the environmental model data are compared with the shapes and contours derived from the sensor data. If, for example, lidar point clouds are used as the sensor data, a parked vehicle at the edge of the road can be described, for example, by a multiplicity of individual reflection points at a certain observation angle. Such reflection points may be arranged in an L-shaped and/or I-shaped manner, for example. In this example, L-shaped and I-shaped contours may therefore be derived from the sensor data. In a similar manner, such contours and shapes may be derived from the environmental model data.

Additional objects may therefore be inferred in an advantageous manner by comparing the shapes and contours. If, for example, a reflection point cannot be assigned to a static object in the environmental model data or if a reflection point cannot be assigned to any of the shapes and contours derived from the environmental model data, this can indicate a non-static object. In this case, it is particularly advantageous if the unassigned reflection point or the unassigned point in the lidar point cloud alone does not suffice to detect and/or classify the non-static object. As a result of such a comparison, the vulnerable road users, in particular, that cannot be detected and/or classified using object detection inside the sensor and/or vehicle can therefore be detected and/or classified in good time and in a more reliable manner.

In a further embodiment, a confidence value for one of the vulnerable road users, which is determined during object detection inside the vehicle, is increased if the vulnerable road user described by the sensor data is located between the sensor and an object described by the environmental model data, wherein the object described by the environmental model data is at most partially described by the sensor data. In other words, it may be the case that a non-static object or a vulnerable road user is located between the sensor and a static object. Consequently, the static object cannot be captured or classified or cannot be completely captured or classified. If the vulnerable road user or the non-static object is also physically such that it can be captured and/or classified only with difficulty, to a restricted extent or not at all for the object detection inside the vehicle, a traffic-critical situation may arise. This may be the case, for example, when the vulnerable road user absorbs radar or lidar beams or in the case of a camera in poor visibility and corresponding clothing of the vulnerable road user.

The object detection inside the vehicle typically assigns a confidence value or an existence probability to each detected object. The value may indicate how reliable the sensor measurement and/or classification is. It may be the case, on account of numerous factors, for example the physical nature of the vulnerable road user and the reflection properties associated therewith and/or the visibility associated therewith in corresponding visibility, that a vulnerable road user or a non-static object is not detected at all or indeed is detected to some extent, but is assigned a very low confidence value. This may result in the object initially being ignored in order to avoid the risk of false tripping of functions. The detection of the vulnerable road users can be improved by comparing the sensor data and the environmental model data because the vulnerable road user can additionally be implicitly confirmed on the basis of the concealed static object. The confidence value can therefore be increased in this case. Furthermore, it is also conceivable for an object to thus be formed for the first time from the point of view of the assistance system. In other words, an implicit gain in knowledge relating to a non-static object, that is to say the vulnerable road user, is therefore achieved in this case by not capturing static objects.

Finally, it is advantageous if characteristic distinguishing features between the sensor data and the environmental model data for detecting the vulnerable road users are not determined if a confidence value for the vulnerable road users, which is determined during object detection inside the vehicle, exceeds a predefined plausibility threshold value. If a vulnerable road user can already be reliably captured and/or classified using the object detection inside the vehicle on the basis of the sensor data alone, the implicit knowledge gain described above can be dispensed with. A confidence value or an existence probability, which indicates a reliability of a classification and/or a sensor measurement, can be used to describe whether a vulnerable road user is reliably captured and/or classified.

The confidence value can typically be in the range between 0 and 1 or in the range from 0% to 100%. If the confidence value exceeds a predefined threshold, that is to say the plausibility threshold value, the sensor measurement and/or the object classification can usually be classified as sufficiently reliable. For example, the plausibility threshold value may be 0.7 or 70%. If a vulnerable road user or a non-static object is captured and classified by the sensor, where the confidence value is 0.8 or 80%, it is possible to dispense with an implicit knowledge gain by comparing the sensor data with the environmental model data. In other words, characteristic distinguishing features between the sensor data and the environmental model data for detecting the vulnerable road user may therefore not be determined in this case.

A further aspect of the invention relates to an assistance system for a vehicle for monitoring a region surrounding the vehicle. The assistance system comprises a sensor for providing sensor data which describe the region surrounding the vehicle at a measurement time. The assistance system also comprises a communication apparatus for receiving environmental model data from a data exchange device, wherein the environmental model data describe at least one part of the region surrounding the vehicle. Finally, the assistance system comprises a control unit for detecting vulnerable road users in the surrounding region on the basis of the sensor data and the environmental model data, wherein the detection of the vulnerable road users comprises determining characteristic distinguishing features between the sensor data and the environmental model data.

A further aspect of the invention relates to a vehicle having an assistance system according to the invention. The vehicle may be in the form of an automobile, in particular.

A further aspect of the invention relates to a vehicle-external data exchange device comprising a computing apparatus for continuously generating environmental model data which describe only static objects in at least one part of a region surrounding a vehicle. The data exchange device also comprises a transmitting apparatus for transmitting the environmental model data to an assistance system of a vehicle.

A further aspect of the invention relates to a system for carrying out a method according to the invention for monitoring a region surrounding a vehicle, comprising an assistance system according to the invention and a data exchange device according to the invention.

The preferred embodiments and their advantages presented with respect to the method according to the invention accordingly apply to the data exchange device according to the invention, the assistance system according to the invention, the vehicle according to the invention and the system according to the invention for carrying out a method according to the invention for monitoring a region surrounding a vehicle.

Further features of the invention emerge from the claims, the figures and the description of the figures. The features and combinations of features mentioned above in the description and the features and combinations of features mentioned below in the description of the figures and/or shown in the figures alone can be used not only in the respectively stated combination but also in other combinations or alone, without departing from the scope of the invention.

The invention is now explained in more detail using preferred exemplary embodiments and with reference to the accompanying drawings.

### BRIEF DESCRIPTION OF THE DRAWINGS

FIG. 1 shows an inner-city traffic situation in which a vehicle captures a surrounding region by means of a sensor;

FIG. 2 shows an illustration of environmental model data according to the traffic situation from FIG. 1, wherein the environmental model data describe only static objects;

FIG. 3 shows an illustration of the comparison of the sensor data according to FIG. 1 with the environmental model data according to FIG. 2;

FIG. 4 shows a schematic illustration of a system for carrying out a method for monitoring a region surrounding a vehicle, comprising an assistance system and a data exchange device.

In the figures, identical or functionally identical elements are provided with the same reference signs.

### DETAILED DESCRIPTION OF THE DRAWINGS

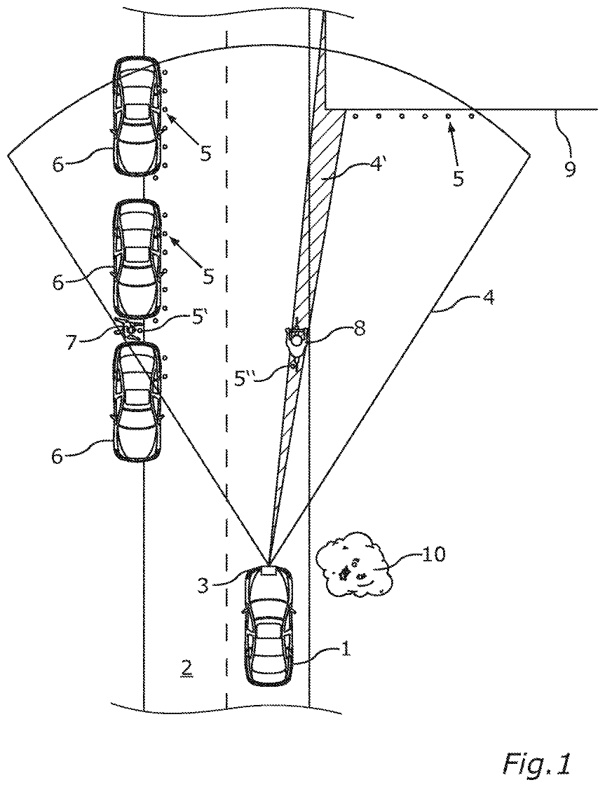

FIG. 1 shows a schematic illustration of an inner-city traffic situation in a plan view. In this case, a vehicle 1, which is in the form of an automobile, is moving on a road 2 in a direction of travel. The vehicle 1 comprises a sensor 3 which captures a region 4 surrounding the vehicle 1 at a measurement time. In this example, the sensor 3 may be in the form of a radar or lidar sensor. The region 4 surrounding the vehicle 1 is described by means of sensor data 5 which are illustrated in the form of reflection points. The reflection points are in turn combined to form a so-called point cloud which, in this example, forms the sensor data 5. One of the reflection points in the point cloud/sensor data 5 can typically be determined by a time-of-flight measurement of an emitted electromagnetic wave which is reflected at an object in the region 4 surrounding the vehicle 1.

Furthermore, parked vehicles 6 are illustrated in the left-hand lane of the road 2. There is also a pedestrian 7 between the parked vehicles 6. The pedestrian 7 is described by means of a reflection point 5′ which is part of the sensor data 5. A cyclist 8 described by means of a reflection point 5″ in the sensor data from the sensor 3 is located ahead of the vehicle 1 in the direction of travel. In addition, the cyclist 8 located between the sensor 3 and a building 9 conceals the view of a part of the building 9 from the sensor 3. This concealment is illustrated by means of a hatched region 4′. In addition, there is a tree 10 beside the vehicle 1.

The parked vehicles 6, the building 9 and the tree 10 are static objects. The pedestrian 7 and the cyclist 8 are non-static objects. Since these non-static objects are relatively unprotected with respect to the vehicle 1, they are also referred to as vulnerable road users.

In order to improve the detection of the vulnerable road users by the assistance system 11 of the vehicle 1, the assistance system 11 of the vehicle 1 may receive, in addition to the sensor data 5, environmental model data, which describe only the static objects, that is to say for example the parked vehicles 6, the building 9 and the tree 10, of at least one part of the region 4 surrounding the vehicle 1, from a data exchange device 14. The detection of the vulnerable road users, that is to say the pedestrian 7 and the cyclist 8, can be improved by determining characteristic distinguishing features between the sensor data 5 and the environmental model data.

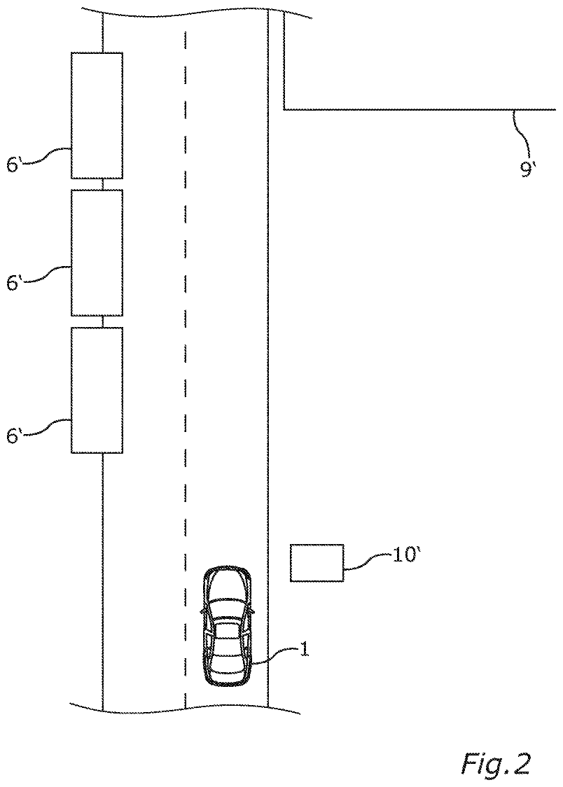

FIG. 2 shows environmental model data according to the traffic situation from FIG. 1, wherein the environmental model data describe only static objects, that is to say the parked vehicles 6, the building 9 and the tree 10. In the example shown, the environmental model data comprise enveloping cuboids 6′ for the parked vehicles 6, an enveloping cuboid 9′ for the building 9 and an enveloping cuboid 10′ for the tree 10, which are continuously transmitted from a data exchange device 14 to the assistance system 11 of the vehicle 1.

The environmental model data are continuously generated by the data exchange device 14 and are therefore always up to date. In particular, it can also be taken into account that one of the parked vehicles 6 is possibly parked only for a short time. The environmental model data, comprising cuboids 6′, 9′ and 10′, may be generated, for example, by means of data from further vehicles 1′ or else by means of data from sensors which are fitted to infrastructure units and have already captured a part of the region 4 surrounding the vehicle 1 at an earlier time.

Further vehicles 1′ or sensors of infrastructure units, for example light signaling systems or traffic monitoring systems, may provide the data exchange device 14 with data. The data exchange device 14 can therefore determine the static environment, comprising the parked vehicles 6, the building 9 and the tree 10, in the at least one part of the region 4 surrounding the vehicle 1 by averaging the data, for example.

Environmental model data generated in this manner can now be used to already detect the vulnerable road users, that is to say for example the pedestrian 7 and/or the cyclist 8, in good time and in a reliable manner.

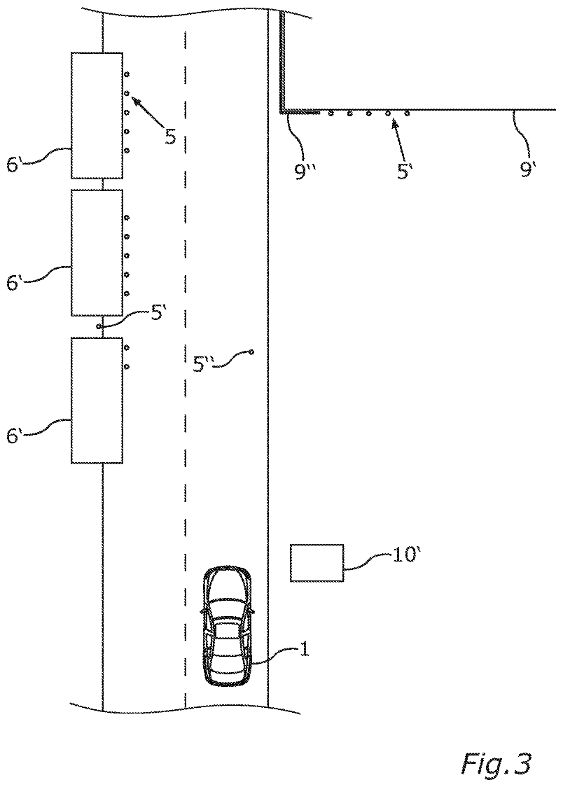

FIG. 3 shows an illustration of the comparison of the sensor data 5 according to FIG. 1 with the environmental model data, that is to say the cuboids 6′, 9′ and 10′, according to FIG. 2. A region 9″ of the building 9 or a region 9″ of the enveloping cuboid 9′, which describes the building 9 as part of the environmental model data, is additionally highlighted by a thick line. This region 9″ is concealed from the sensor 3 of the vehicle 1 by the cyclist 8.

It may be the case that reflection properties of the pedestrian 7 and/or of the cyclist 8 are such that, although the pedestrian 7 and/or the cyclist 8 can be described by a reflection point 5′ and 5″ as part of the sensor data 5, the signal and/or the quality of the sensor measurement do(es) not suffice to reliably capture or classify the pedestrian 7 and/or the cyclist 8.

In order to nevertheless capture and in particular classify the vulnerable road users, that is to say the pedestrian 7 and/or the cyclist 8, the sensor data 5 may be compared with the environmental model data. In this case, shapes and contours may be derived from the sensor data 5 and may be compared with the shapes and contours in the environmental model data. Furthermore, it is possible for each reflection point to be assigned to an object in the environmental model data, that is to say for example one of the enveloping cuboids 6′, 9′ and/or 10′, if possible.

It may be the case, for example, that the reflection point 5″ cannot be assigned to any static object in the environmental model data or the reflection point 5″ cannot be assigned to any of the enveloping cuboids 6′, 9′ and/or 10′. However, since the region 9″ cannot be captured by the sensor 3, this can implicitly indicate the cyclist 8. In this case, the method according to the invention improves the detection of vulnerable road users, in particular the detection of the cyclist 8, and therefore also the monitoring of the region 4 surrounding the vehicle 1.

In this example, the cyclist can be captured and/or classified with the aid of an implicit knowledge gain. In this case, the implicit knowledge gain is based on an indirect observation of an exoplanet which can be observed only on the basis of the brightness fluctuations of its central star.

In a similar manner, it may be the case, for example, that the reflection point 5′ cannot be assigned to any static object in the environmental model data or the reflection point 5′ cannot be assigned to any of the enveloping cuboids 6′, 9′ and/or 10′. However, since the static objects, that is to say the parked vehicles 6, the building 9 and the tree 10, are known to the assistance system 11 of the vehicle 1 on the basis of the environmental model data, the capture and/or classification of the pedestrian 7 can likewise be improved. Alternatively or additionally, it is already possible to react to the pedestrian 7 in good time. For example, a driver of the vehicle 1 may thus be prewarned. A request for the driver to take over the control of the vehicle 1 in the form of a so-called hands-on request is likewise contemplated. This also applies in the case of further vulnerable road users.

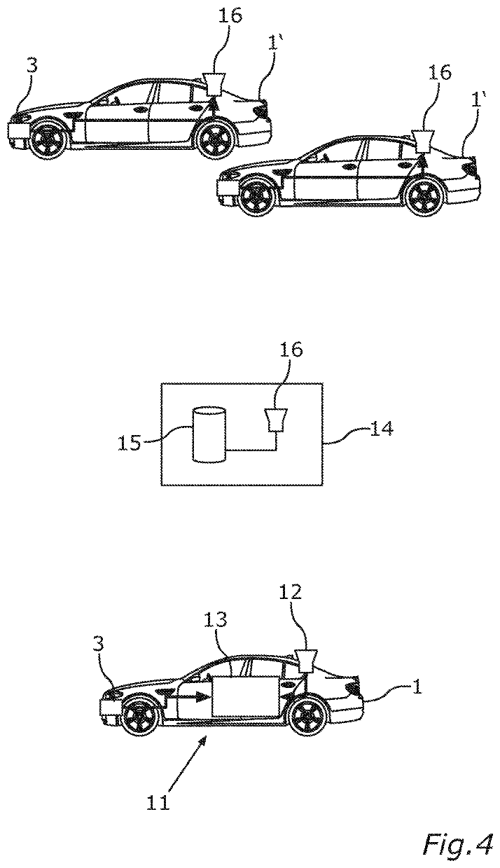

FIG. 4 shows a schematic illustration of a system for carrying out a method for monitoring a region 4 surrounding the vehicle 1. The vehicle 1 comprises an assistance system 11. The assistance system 11 comprises a sensor 3, a communication apparatus 12 and a control unit 13 for detecting vulnerable road users.

A data exchange device 14 comprises a computing apparatus 15 and a transmitting apparatus 16 for transmitting the environmental model data to an assistance system 11 of a vehicle 1. In this case, the environmental model data may be generated by means of data from at least two further sources, here illustrated in the form of further vehicles 1′. In this case, the further vehicles 1′ comprise at least one environmental sensor 3′, for example a radar, lidar and/or ultrasonic sensor and/or a camera, as well as an additional transmitting apparatus 16 for providing the data exchange device 14 with the data from the environmental sensor(s) 3′.

1.-10. (canceled)

11. A method for monitoring a region surrounding a vehicle, the method comprising the steps of:
receiving sensor data from at least one sensor of an assistance system of the vehicle which describe the region surrounding the vehicle at a measurement time;
transmitting environmental model data from a data exchange device to the assistance system, wherein the environmental model data describe at least one part of the region surrounding the vehicle; and
detecting vulnerable road users in the surrounding region on the basis of the sensor data and the environmental model data,
wherein
the environmental model data are continuously generated by the data exchange device and transmitted to the assistance system,
the environmental model data are generated such that they describe only static objects in the at least one part of the surrounding region, and
the detection of the vulnerable road users comprises determining characteristic distinguishing features between the sensor data and the environmental model data.

12. The method according to claim 11, wherein
the environmental model data are generated by data from at least two further sources which were recorded within a recording period.

13. The method according to claim 12, wherein
the measurement time of the sensor data temporally follows the recording period of the data from the at least two further sources.

14. The method according to claim 12, wherein
the recording period of the data from the at least two further sources is within a predetermined maximum period.

15. The method according to claim 11, wherein
when determining the characteristic distinguishing features for detecting the vulnerable road users, shapes and contours derived from the environmental model data are compared with shapes and contours derived from the sensor data.

16. The method according to claim 11, wherein
a confidence value for one of the vulnerable road users, which is determined during object detection inside the vehicle, is increased when a vulnerable road user described by the sensor data is located between the sensor and an object described by the environmental model data, wherein the object described by the environmental model data is at most partially described by the sensor data.

17. The method according to claim 11, wherein
characteristic distinguishing features between the sensor data and the environmental model data for detecting the vulnerable road users are not determined when a confidence value for a vulnerable road user, which is determined during object detection inside the vehicle, exceeds a predefined plausibility threshold value.

18. An assistance system for a vehicle for monitoring a region surrounding the vehicle, comprising:
a sensor for providing sensor data which describe the region surrounding the vehicle at a measurement time;
a communication apparatus for receiving environmental model data from a data exchange device, wherein the environmental model data describe at least one part of the region surrounding the vehicle; and
a control unit for detecting vulnerable road users in the surrounding region on the basis of the sensor data and the environmental model data, wherein the detection of the vulnerable road users comprises determining characteristic distinguishing features between the sensor data and the environmental model data.

19. A data exchange device, comprising:
a computing apparatus for continuously generating environmental model data which describe only static objects in at least one part of a region surrounding a vehicle; and
a transmitting apparatus for transmitting the environmental model data to an assistance system of a vehicle.

20. A system for monitoring a region surrounding a vehicle, comprising:
(i) an assistance system, comprising:
a sensor for providing sensor data which describe the region surrounding the vehicle at a measurement time;
a communication apparatus for receiving environmental model data, wherein the environmental model data describe at least one part of the region surrounding the vehicle; and
a control unit for detecting vulnerable road users in the surrounding region on the basis of the sensor data and the environmental model data, wherein the detection of the vulnerable road users comprises determining characteristic distinguishing features between the sensor data and the environmental model data;
(ii) a data exchange device, comprising:
a computing apparatus for continuously generating environmental model data which describe only static objects in at least one part of a region surrounding a vehicle; and
a transmitting apparatus for transmitting the environmental model data to the assistance system.
